(19) United States
(12) Patent Application Publication
(10) Pub. No.: US 2025/0378828 A1
(43) Pub. Date: Dec. 11, 2025

(54) METHOD, APPARATUS, DEVICE AND STORAGE MEDIUM FOR SPEECH RECOGNITION

(71) Applicants: Beijing Zitiao Network Technology Co., Ltd., Beijing (CN); Lemon Inc., Grand Cayman (KY)

(72) Inventors: Linhao DONG, Beijing (CN); Lu LU, Los Angeles, CA (US)

(21) Appl. No.: 19/234,640

(22) Filed: Jun. 11, 2025

(30) Foreign Application Priority Data
Jun. 11, 2024 (CN) 202410749781.8

(51) Int. Cl. G10L 15/183; G10L 15/06

(52) U.S. Cl. CPC G10L 15/183; G10L 15/063

(57) ABSTRACT

Embodiments of the disclosure relates to a method, apparatus, device and storage medium for speech recognition. An example method includes: obtaining target speech content; processing, with a speech encoding unit, the target speech content to generate a speech encoding representation; converting, with a conversion unit, the speech encoding representation into a speech feature sequence; constructing an input feature sequence based on the speech feature sequence and a prompt feature sequence, the prompt feature sequence being constructed based on a predetermined prompt item; and processing the input feature sequence with a language model to generate a speech recognition result of the target speech content. The embodiments of the disclosure can implement, with a language model, speech recognition based on a feature sequence.

### CROSS-REFERENCE

This application claims the priority of Chinese Patent Application No. 202410749781.8, filed Jun. 11, 2024, and entitled “METHOD, APPARATUS, DEVICE AND STORAGE MEDIUM FOR SPEECH RECOGNITION,” the entire contents of which is incorporated herein by reference.

### FIELD

Example embodiments of the present disclosure generally relate to the field of computers, and in particular, to a method, apparatus, device and computer-readable storage medium for speech recognition.

### BACKGROUND

With the development of Internet and computer technologies, natural language processing has been developed. In the field of natural language processing, speech recognition models have been widely concerned and used. Therefore, the recognition effect of the speech recognition model becomes a focus problem concerned by people.

### SUMMARY

In a first aspect of the present disclosure, a method of speech recognition is provided. The method includes: obtaining target speech content; processing, with a speech encoding unit, the target speech content to generate a speech encoding representation; converting, with a conversion unit, the speech encoding representation into a speech feature sequence; constructing an input feature sequence based on the speech feature sequence and a prompt feature sequence, the prompt feature sequence being constructed based on a predetermined prompt item; and processing the input feature sequence with a language model to generate a speech recognition result of the target speech content.

In a second aspect of the present disclosure, an apparatus for speech recognition is provided. The apparatus includes: an obtaining module configured to obtain target speech content; a processing module configured to process, with a speech encoding unit, the target speech content to generate a speech encoding representation; a converting module is configured to convert, with a conversion unit, the speech encoding representation into a speech feature sequence; a constructing module configured to construct an input feature sequence based on the speech feature sequence and a prompt feature sequence, the prompt feature sequence being constructed based on a predetermined prompt item; and a generating module configured to process the input feature sequence with a language model to generate a speech recognition result of the target speech content.

In a third aspect of the present disclosure, an electronic device is provided. The device includes at least one processor; and at least one memory coupled to the at least one processor and storing instructions for execution by the at least one processor, the instructions, when executed by the at least one processor, causing the electronic device to perform the method of the first aspect.

In a fourth aspect of the present disclosure, a computer-readable storage medium is provided. The computer-readable storage medium has a computer program stored thereon, the computer program being executable by a processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, where:

FIG. 1 illustrates a schematic diagram in which an example environment may be implemented according to embodiments of the present disclosure;

FIG. 2 shows a flowchart of an example speech recognition process according to some embodiments of the present disclosure;

FIG. 3 illustrates a block diagram of an example speech recognition according to some embodiments of the present disclosure;

FIG. 4 illustrates a schematic structural block diagram of an example apparatus for speech recognition according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms and should not be construed as limited to the embodiments set forth herein. Rather, these embodiments are provided for a more thorough and complete understanding of the present disclosure. It should be understood that the drawings and embodiments of the present disclosure are for example purposes only and are not intended to limit the scope of the present disclosure.

It should be noted that the title of any section/subsection provided herein is not limiting. Various embodiments are described throughout, and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the term “including” and the like should be understood to include “including but not limited to”. The term “based on” should be understood as “based at least in part on”. The term “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

The embodiments of the present disclosure may involve data of the user, obtaining and/or using the data, and the like. These aspects all follow the corresponding laws and regulations and related regulations. In the embodiments of the present disclosure, all data is collected, obtained, processed, handled, forwarded, used, etc., all of which are performed on the premise the knowledge and confirmation of the user. Accordingly, in a case where implementing the embodiments of the present disclosure, the types of the data or information that may be involved, the usage scope, the usage scenario, and the like should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, personal information processing is involved, processing may be performed on the premise of having a legality basis (for example, obtaining consent of a personal information subject, or necessary for performing a fulfillment contract), and processing only within a specified or agreed range. The user rejects personal information other than necessary information required by the basic function, and does not affect the basic function of the user.

The automatic speech recognition framework is also undergoing continuous iteration with the rapid development of deep neural networks. According to traditional schemes, the more mainstream speech recognition models are mainly based on end-to-end frameworks, such as recurrent neural network transducers and attention-based encoder-decoders. These end-to-end speech recognition models rely entirely on neural network modeling, which is limited by model capacity and training methods, and its recognition effect still needs to be improved.

The embodiment of the present disclosure provides a speech recognition scheme. According to the scheme, target speech content can be obtained; the speech coding unit is processed, with a speech encoding unit, to generate a speech coded representation; the conversion unit is converted, with a conversion unit, into a speech feature sequence; an input feature sequence is constructed based on the speech feature sequence and a prompt feature sequence, the prompt feature sequence being constructed based on a predetermined prompt item; and the input feature sequence is processed with a language model to generate a speech recognition result of the target speech content.

In this way, the embodiments of the present disclosure can construct an input feature sequence based on the speech feature sequence and a prompt feature sequence, and process the input feature sequence with a language model to generate a speech recognition result of the target speech content. Therefore, the embodiments of the present disclosure can realize, with the language model, the speech recognition based on the feature sequence, thereby improving the accuracy of speech recognition.

Various example implementations of this scheme are described in detail below in conjunction with the accompanying drawings.

### Example Environment

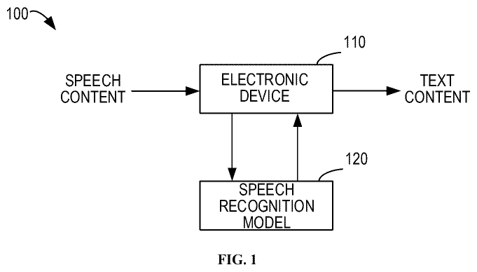

FIG. 1 illustrates a schematic diagram of an example environment 100 in which embodiments of the present disclosure may be implemented. As shown in FIG. 1, the example environment 100 may include an electronic device 110 and a speech recognition model 120.

In this example environment 100, the electronic device 110 completes a speech recognition task based on invoking the speech recognition model 120. The electronic device 110 is at least configured to output the received speech content as corresponding text content.

In some embodiments, the electronic device 110 may establish a communication connection with the speech recognition model 120. That is, the electronic device 110 may invoke a local or remote speech recognition model 120 to obtain input speech content from the electronic device 110 and convert the speech content into corresponding text content.

In some embodiments, the electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of interface for a user (such as a “wearable” circuit, etc.).

It should be understood that the structures and functions of the various elements in the environment 100 are described for example purposes only and do not imply any limitation to the scope of the present disclosure.

### Example Processes

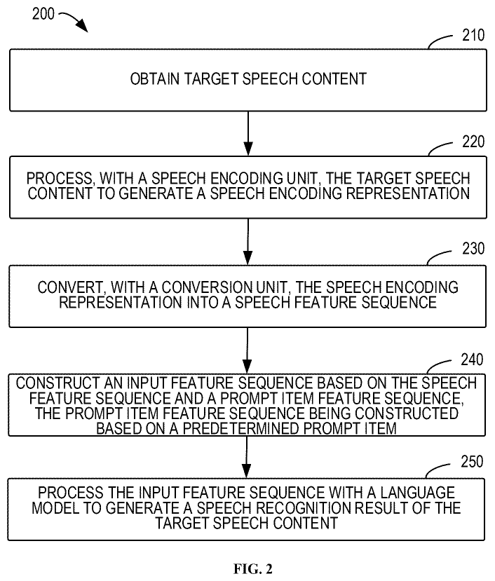

FIG. 2 shows a flowchart of a speech recognition example process 200 according to some embodiments of the present disclosure. The process 200 may be implemented at the electronic device 110. The process 200 is described below with reference to FIG. 1.

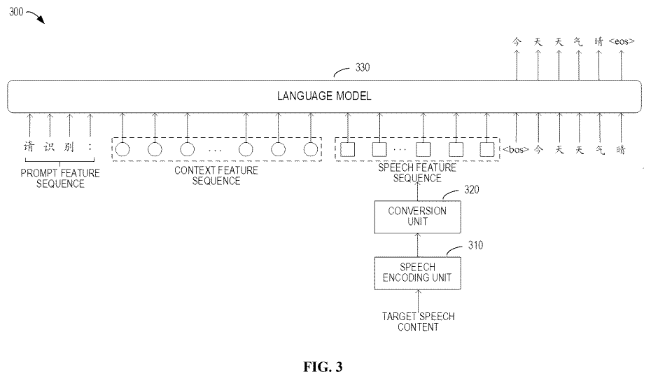

Referring to FIG. 3, a speech recognition model 300 includes a speech encoding unit 310, a conversion unit 320, and a language model 330. In some embodiments, the electronic device 110 may perform the speech recognition task based on invoking the speech recognition model 300.

As shown in FIG. 2, at block 210, the electronic device 110 obtains target speech content.

In some embodiments, the target speech content may be speech of a plurality of language types, it may be understood that such plurality of language types may include different types of languages, such as Chinese, English, Japanese, etc., and the present disclosure is not intended to limit the type of the language.

At block 220, the electronic device 110 processes with a speech encoding unit, the target speech content to generate a speech encoding representation.

In some embodiments, the electronic device 110 processes, with the speech encoding unit 310, an acoustic feature of the target speech content to generate a speech encoding representation. As an example, the electronic device 110 takes an acoustic feature sequence or waveform information corresponding to a piece of speech or audio: X={x_1, x_2, . . . x_T} as input, and after structural modeling by the speech encoding unit 310, encodes to obtain the corresponding speech code representation H={h_1, h_2, . . . , h_{T′}}. In this regard, T and T′ represent sequence lengths before and after encoding, respectively.

At block 230, the electronic device 110 converts, with a conversion unit, the speech encoding representation into a speech feature sequence.

In some embodiments, the electronic device 110 downsamples, with the conversion unit 320, the speech encoding representation to generate an intermediate feature sequence, and map the intermediate feature sequence to a feature dimension corresponding to the language model 330 to generate the speech feature sequence.

As an example, the electronic device 110 receives, based on the conversion unit 320, a speech encoding representation H={h_1, h_2, . . . , h_{T′}} of the speech encoding unit 310. The speech encoding representation H={h_1, h_2, . . . , h_{T′}}. Further, the electronic device 110 maps the intermediate feature sequence after the completion of downsampling to a feature dimension of the language model 330 based on the conversion unit 320, which is often performed through a linear layer. The intermediate feature sequence, after passing through the conversion unit 320, may be obtained as a speech feature sequence A={a_1a_2, . . . , a_{T″}} input to the language model 330.

At block 240, the electronic device 110 constructs an input feature sequence based on the speech feature sequence and a prompt feature sequence, the prompt feature sequence being constructed based on a predetermined prompt item.

In some embodiments, such a prompt item is for instructing the language model 330 to generate a speech recognition result corresponding to the speech feature sequence. For example, the content of this prompt item may be “Please convert a corresponding speech recognition result in conjunction with the provided target speech content.”

In some embodiments, the electronic device 110 may further obtain contextual information associated with the target speech content. For example, text content generated based on historical speech content associated with the target speech content; scene information for describing a dialog scenario associated with the target speech content; and object information for describing at least one object associated with the target speech content. In this way, the language model 330 may cause the speech recognition model 300 to output a speech recognition result that is more accurate and more in line with the expectations of the user based on this contextual information.

It should be understood that the text content, scene information, object information, and other data (including but not limited to the data itself, obtaining or use of data) mentioned in the present disclosure should follow the requirements of the corresponding laws and regulations and related regulations.

In some embodiments, the electronic device 110 constructs the input feature sequence based on the above-mentioned speech feature sequence, the prompt feature sequence, and a context feature sequence corresponding to the contextual information.

At block 250, the electronic device 110 processes the input feature sequence with a language model to generate a speech recognition result of the target speech content.

In some embodiments, the electronic device 110 inputs the obtained input feature sequence into the language model 330 to obtain a speech recognition result corresponding to the target speech content. Referring to FIG. 3, such input feature sequence may, for example, be processed in the order of prompt feature sequence, context feature sequence to speech feature sequence. In this manner, the electronic device 110 may accelerate the processing of contextual information, thereby improving speech recognition efficiency.

In some embodiments, the training process of the speech recognition model 300 will be described below.

The electronic device 110 pre-trains, in a first stage, the speech encoding unit 310 with a first training dataset including a first set of speech samples. Such first set of speech samples may be, for example, different types of speech samples such as Chinese, English and Japanese.

In some embodiments, the speech encoding unit 310 may be pre-trained based on an self-supervised training process. As an example, the electronic device 110 may use a set of unlabeled speech data to pre-train the speech encoding unit 310 through a self-supervised learning process so that the speech encoding unit 310 automatically converts the set of unlabeled speech data into a corresponding speech encoding representation. During the pre-training process, the electronic device 110 may adjust parameters of the speech coding unit 310 based on a loss function of the self-supervised learning process.

In this way, the electronic device 110 improves the capacity of the speech recognition model 300 based on a large number of first training datasets to obtain the speech recognition model 300 that may have a good cognitive ability for speech information.

The electronic device 110 adjusts, in a second stage, parameters of the trained speech encoding unit 310 and the conversion unit 320 with a second training dataset, the second training dataset including a second set of speech samples and first labeled texts corresponding to the second set of speech samples. In some embodiments, such second training dataset, for example, may be speech text pairs.

In some embodiments, the electronic device 110 may perform the second stage of training based on a large amount of speech text constituting supervised data, to adjust the parameters of the trained speech encoding unit 310 and the conversion unit 320 described above. As an example, this first labeled text may serve as the labeling information for this second set of speech samples. Based on this labeling information, the electronic device 110 compares the speech recognition results output by the language model 330 to obtain a first training loss. The electronic device 110 adjusts, based on this first training loss, the parameters of the trained speech encoding unit 310 and the conversion unit 320, thereby training the speech recognition model 300.

In some embodiments, the training process of the speech recognition model 300 further includes a third stage. The electronic device 110 adjusts, in the third stage, parameters of the speech encoding unit 310 and the conversion unit 320 with a third training dataset, the third training dataset including a third set of speech samples, sample contextual information associated with the third set of speech samples, and second labeled texts corresponding to the third set of speech samples.

Similarly, the electronic device 110 obtains the speech recognition result of the language model 330 based on the third set of speech samples and sample contextual information associated with the third set of speech samples. The electronic device 110 compares this speech recognition result, and second text labeling information corresponding to the third set of speech samples, to obtain a second training loss. The electronic device 110 adjusts the parameters of the speech encoding unit 310 and the conversion unit 320 based on this second training loss, so as to continue training the speech recognition model 300.

In some embodiments, a first training loss of the second stage and a second training loss of the third stage is determined based on a cross-entropy loss associated with the language model 330.

In some embodiments, the training process of the speech recognition model 300 further includes a fourth stage. The electronic device 110 processes, in the fourth stage, a fourth set of speech samples with the speech recognition model 300 to generate a set of recognized texts. The electronic device 110 determines evaluation information about the set of recognized texts based on the set of recognized texts and a set of labeled texts corresponding to the fourth set of speech samples.

In some embodiments, as with the third phase, the electronic device 110 also performs the fourth stage of training based on a certain number of triplets including contextual information-speech content-text labeling information. Unlike the third stage, in the fourth stage, the electronic device 110 will construct an objective function for the fourth stage of training based on at least one evaluation metric (e.g., a word error rate (WER)). Based on this objective function, the electronic device 110 evaluates a set of recognized texts generated from the fourth set of speech samples and the set of labeled texts corresponding to the fourth set of speech samples to determine evaluation information for the set of recognized texts.

In some embodiments, the electronic device 110 determines, based on the evaluation information, the third training loss corresponding to the fourth stage.

In this way, the electronic device 110 may, for example, optimize the WER or the like, so that the speech recognition model 300 learns by minimizing the WER as an optimization criterion during training, further improving the speech recognition accuracy of the speech recognition model 300.

In some embodiments, the electronic device 110 adjusts, based on the third training loss, the parameters of the speech encoding unit 310 and the conversion unit 320.

In some embodiments, the electronic device 110 may adjust parameters of the language model 330 to train the speech recognition model 300 based on a first training loss, a second training loss, or a third training loss, respectively, in a second stage, a third stage, or a fourth stage. As an example, in the process of training the speech recognition model 300, the electronic device 110 may fix parameters of the language 330; alternatively, the electronic device 110 may fine-tune the parameters of the language model 330; alternatively, the electronic device 110 may also adjust parameters of a fine-tuning module (e.g., a Low-Rank Adaptation (Lora) module) associated with the language model 330.

In this way, the embodiments of the present disclosure may construct an input feature sequence based on the speech feature sequence and a prompt feature sequence, and process the input feature sequence with a language model to generate a speech recognition result of the target speech content. As a result, the embodiments of the present disclosure are able to implement feature sequence-based speech recognition using a language model, thereby improving the accuracy of speech recognition.

### Example Apparatus and Device

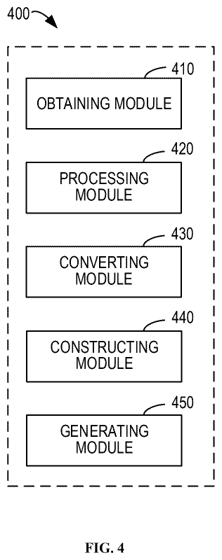

Embodiments of the present disclosure also provide a corresponding apparatus for implementing the above method or process. FIG. 4 shows a schematic structural block diagram of an example apparatus for speech recognition 400 according to some embodiments of the present disclosure. The apparatus 400 may be implemented or included in the electronic device 110. The various modules/components in the apparatus 400 may be implemented by hardware, software, firmware, or any combination thereof.

As shown in FIG. 4, the apparatus 400 includes an obtaining module 410 configured to obtain target speech content; a processing module 420 configured to process, with a speech encoding unit, the target speech content to generate a speech encoding representation; a converting module 430 configured to convert, with a conversion unit, the speech encoding representation into a speech feature sequence; a constructing module 440 configured to construct an input feature sequence based on the speech feature sequence and a prompt feature sequence, the prompt feature sequence being constructed based on a predetermined prompt item; and a generating module 450 configured to process the input feature sequence with a language model to generate a speech recognition result of the target speech content.

In some embodiments, the constructing module 440 is configured to obtain contextual information associated with the target speech content; and construct the input feature sequence, the input feature sequence including the speech feature sequence, the prompt feature sequence, and a context feature sequence corresponding to the contextual information.

In some embodiments, the contextual information indicates at least one of the following: text content generated based on historical speech content associated with the target speech content; scenario information for describing a dialog scenario associated with the target speech content; or object information for describing at least one object associated with the target speech content.

In some embodiments, the prompt item is configured to indicate the language model to generate the speech recognition result corresponding to the speech feature sequence.

In some embodiments, the processing module 420 is configured to process, with the speech encoding unit, an acoustic feature of the target speech content to generate the speech encoding representation.

In some embodiments, the converting module 430 is configured to down-sample the speech encoding representation to generate an intermediate feature sequence; and map the intermediate feature sequence to a feature dimension corresponding to the language model, to generate the speech feature sequence.

In some embodiments, the speech recognition model includes the speech encoding unit, the conversion unit, and the language model, and a training process of the speech recognition model includes: pre-training, in a first stage, the speech encoding unit with a first training dataset including a first set of speech samples; and adjusting, in a second stage, parameters of the trained speech encoding unit and the conversion unit with a second training dataset, the second training dataset including a second set of speech samples and first labeled texts corresponding to the second set of speech samples.

In some embodiments, in the first stage, the speech encoding unit is pre-trained based on an self-supervised training process.

In some embodiments, the training process of the speech recognition model further includes: adjusting, in a third stage, parameters of the speech encoding unit and the conversion unit with a third training dataset, the third training dataset including a third set of speech samples, sample contextual information associated with the third set of speech samples, and second labeled texts corresponding to the third set of speech samples.

In some embodiments, a first training loss of the second stage and/or a second training loss of the third stage is determined based on a cross-entropy loss associated with the language model.

In some embodiments, the training process of the speech recognition model further includes: processing, in a fourth stage, a fourth set of speech samples with the speech recognition model to generate a set of recognized texts; determining a third training loss corresponding to the fourth stage based on the set of recognized texts and a set of labeled texts corresponding to the fourth set of speech samples; and adjusting, based on the third training loss, the parameters of the speech encoding unit and the conversion unit.

In some embodiments, determining the third training loss corresponding to the fourth stage based on the set of recognized texts and the set of labeled texts corresponding to the fourth set of speech samples includes: determining evaluation information about the set of recognized texts based on the set of recognized texts and the set of labeled texts; and determining, based on the evaluation information, the third training loss corresponding to the fourth stage.

In some embodiments, the training process of the speech recognition model further includes: in at least one of the second stage, the third stage, or the fourth stage, performing one of the following: fixing parameters of the language model; fine-tuning the parameters of the language model; or adjusting parameters of a fine-tuning module associated with the language model.

The modules included in the apparatus 400 may be implemented in various manners, including software, hardware, firmware, or any combination thereof. In some embodiments, one or more units may be implemented using software and/or firmware, such as machine-executable instructions stored on a storage medium. In addition to or as an alternative to machine-executable instructions, some or all of the modules in the apparatus 400 may be implemented, at least in part, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

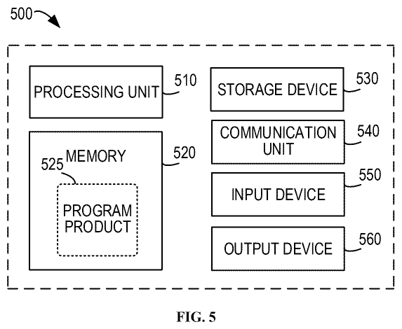

FIG. 5 illustrates a block diagram of an electronic device 500 in which one or more embodiments of the present disclosure may be implemented. It should be understood that the electronic device 500 illustrated in FIG. 5 is merely example and should not constitute any limitation on the functionality and scope of the embodiments described herein. The electronic device 500 shown in FIG. 5 may be configured to implement the electronic device 110 in FIG. 1.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In multiprocessor systems, multiple processing units execute computer-executable instructions in parallel to improve parallel processing capabilities of the electronic device 500.

The electronic device 500 typically includes a plurality of computer storage media. Such media may be any available media accessible to the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium, such as a flash drive, magnetic disk, or any other medium, which may be capable of storing information and/or data and may be accessed within the electronic device 500.

The electronic device 500 may further include additional removable/non-removable, volatile/non-volatile storage media. Although not shown in FIG. 5, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 is configured to communicate with another electronic device through a communication medium. Additionally, the functionality of components of the electronic device 500 may be implemented in a single computing cluster or multiple computing machines capable of communicating over a communication connection. Thus, the electronic device 500 may operate in a networked environment using logical connections with one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the present disclosure, a computer-readable storage medium having computer-executable instructions stored thereon is provided, where the computer program is executable by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are example, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method of speech recognition, comprising:
obtaining target speech content;
processing, with a speech encoding unit, the target speech content to generate a speech encoding representation;
converting, with a conversion unit, the speech encoding representation into a speech feature sequence;
constructing an input feature sequence based on the speech feature sequence and a prompt feature sequence, the prompt feature sequence being constructed based on a predetermined prompt item; and
processing the input feature sequence with a language model to generate a speech recognition result of the target speech content.

2. The method of claim 1, wherein constructing the input feature sequence based on the speech feature sequence and the prompt feature sequence comprises:
obtaining contextual information associated with the target speech content; and
constructing the input feature sequence, the input feature sequence comprising the speech feature sequence, the prompt feature sequence, and a context feature sequence corresponding to the contextual information.

3. The method of claim 2, wherein the contextual information indicates at least one of the following:
text content generated based on historical speech content associated with the target speech content;
scenario information for describing a dialog scenario associated with the target speech content; or
object information for describing at least one object associated with the target speech content.

4. The method of claim 1, wherein the predetermined prompt item is configured to indicate the language model to generate the speech recognition result corresponding to the speech feature sequence.

5. The method of claim 1, wherein processing, with the speech encoding unit, the target speech content to generate the speech encoding representation comprises:
processing, with the speech encoding unit, an acoustic feature of the target speech content to generate the speech encoding representation.

6. The method of claim 1, wherein converting, with the conversion unit, the speech encoding representation into the speech feature sequence comprises:
downsampling the speech encoding representation to generate an intermediate feature sequence; and
mapping the intermediate feature sequence to a feature dimension corresponding to the language model, to generate the speech feature sequence.

7. The method of claim 1, wherein a speech recognition model comprises the speech encoding unit, the conversion unit, and the language model, and a training process of the speech recognition model comprises:
pre-training, in a first stage, the speech encoding unit with a first training dataset comprising a first set of speech samples; and
adjusting, in a second stage, parameters of the speech encoding unit and the conversion unit with a second training dataset, the second training dataset comprising a second set of speech samples and first labeled texts corresponding to the second set of speech samples.

8. The method of claim 7, wherein in the first stage, the speech encoding unit is pre-trained based on an self-supervised training process.

9. The method of claim 7, wherein the training process of the speech recognition model further comprises:
adjusting, in a third stage, parameters of the speech encoding unit and the conversion unit with a third training dataset, the third training dataset comprising a third set of speech samples, sample contextual information associated with the third set of speech samples, and second labeled texts corresponding to the third set of speech samples.

10. The method of claim 9, wherein at least one of a first training loss of the second stage or a second training loss of the third stage is determined based on a cross-entropy loss associated with the language model.

11. The method of claim 7, wherein the training process of the speech recognition model further comprises:
processing, in a fourth stage, a fourth set of speech samples with the speech recognition model to generate a set of recognized texts;
determining a third training loss corresponding to the fourth stage based on the set of recognized texts and a set of labeled texts corresponding to the fourth set of speech samples; and
adjusting, based on the third training loss, the parameters of the speech encoding unit and the conversion unit.

12. The method of claim 11, wherein determining the third training loss corresponding to the fourth stage based on the set of recognized texts and the set of labeled texts corresponding to the fourth set of speech samples comprises:
determining evaluation information about the set of recognized texts based on the set of recognized texts and the set of labeled texts; and
determining, based on the evaluation information, the third training loss corresponding to the fourth stage.

13. The method of claim 7, wherein the training process of the speech recognition model further comprises: performing one of the following:
fixing parameters of the language model;
fine-tuning the parameters of the language model; or
adjusting parameters of a fine-tuning module associated with the language model.

14. An electronic device, comprising:
at least one processor; and
at least one memory coupled to the at least one processor and storing instructions for execution by the at least one processor, the instructions, when executed by the at least one processor, causing the electronic device to perform operations comprising:
obtaining target speech content;
processing, with a speech encoding unit, the target speech content to generate a speech encoding representation;
converting, with a conversion unit, the speech encoding representation into a speech feature sequence;
constructing an input feature sequence based on the speech feature sequence and a prompt feature sequence, the prompt feature sequence being constructed based on a predetermined prompt item; and
processing the input feature sequence with a language model to generate a speech recognition result of the target speech content.

15. The electronic device of claim 14, wherein constructing the input feature sequence based on the speech feature sequence and the prompt feature sequence comprises:
obtaining contextual information associated with the target speech content; and
constructing the input feature sequence, the input feature sequence comprising the speech feature sequence, the prompt feature sequence, and a context feature sequence corresponding to the contextual information.

16. The electronic device of claim 15, wherein the contextual information indicates at least one of the following:
text content generated based on historical speech content associated with the target speech content;
scenario information for describing a dialog scenario associated with the target speech content; or
object information for describing at least one object associated with the target speech content.

17. The electronic device of claim 14, wherein the predetermined prompt item is configured to indicate the language model to generate the speech recognition result corresponding to the speech feature sequence.

18. The electronic device of claim 14, wherein processing, with the speech encoding unit, the target speech content to generate the speech encoding representation comprises:
processing, with the speech encoding unit, an acoustic feature of the target speech content to generate the speech encoding representation.

19. The electronic device of claim 14, wherein converting, with the conversion unit, the speech encoding representation into the speech feature sequence comprises:
downsampling the speech encoding representation to generate an intermediate feature sequence; and
mapping the intermediate feature sequence to a feature dimension corresponding to the language model, to generate the speech feature sequence.

20. A non-transitory computer-readable storage medium having a computer program stored thereon, the computer program being executable by a processor to implement operations comprising:
obtaining target speech content;
processing, with a speech encoding unit, the target speech content to generate a speech encoding representation;
converting, with a conversion unit, the speech encoding representation into a speech feature sequence;
constructing an input feature sequence based on the speech feature sequence and a prompt feature sequence, the prompt feature sequence being constructed based on a predetermined prompt item; and
processing the input feature sequence with a language model to generate a speech recognition result of the target speech content.
